(19) United States
(12) Patent Application Publication
(10) Pub. No.: US 2004/0060149 A1
(43) Pub. Date: Apr. 1, 2004

(54) WHEEL ASSEMBLY FOR A CART

(76) Inventor: Chin-Lin Chang, Feng-Yuan City (TW)

Correspondence Address: Rabin & Berdo, P.C., Suite 500, 1101 14th Street, Washington, DC, 20005, US

(21) Appl. No.: 10/254,864

(22) Filed: Sep. 26, 2002

(51) Int. Cl. B60B 33/00

(52) U.S. Cl. 16/20

(57) ABSTRACT

A wheel assembly includes a wheel seat having a through hole to receive therein a bearing, multiple claws to abut the bearing, and an annular rim. The bearing has a path corresponding to the through hole. An annular cover has a central plate to abut the bearing, a passage defined to communicate with the path of the bearing and a skirt to correspond to the annular rim to securely sandwich the bearing inside the wheel seat. A positioning bolt and a wheel rotatably received in the wheel seat. Abutment of the conical head to the bottom face of the bearing and the engagement of the nut and the central plate secure the bearing in the wheel seat, and after the annular cover is mounted on top of the wheel seat, corresponding relationship between the skirt and the annular rim prevents pollutant from entering the bearing.

### BACKGROUND OF THE INVENTION

1. Field of the Invention

The present invention relates to a wheel assembly, and more particularly to a wheel assembly for a cart. The wheel assembly has a bearing rested in a bearing seat and clamped by claws formed on an inner periphery of the bearing seat. An annular cover is mounted on top of the bearing and has an annularly formed central plate to abut a top face of the bearing so that the bearing is securely seated in the bearing seat.

2. Description of Related Art

With reference to FIG. 4, a conventional wheel assembly for a cart includes a wheel seat (60) and a wheel (50) rotatably received in the wheel seat (60). The wheel seat (60) includes a bottom plate (62), a top plate (64) and a mediate plate (61). The bottom plate (62) and the top plate (64) are detachably connected to the mediate plate (61) by a bolt (66) extending through the bottom plate (62), the mediate plate (61) and the top plate (64). Multiple first balls (63) are rotatably received between the bottom plate (62) and the mediate plate (61). Multiple second balls (65) are rotatably received between the mediate plate (61) and the top plate (64). After the bolt (66) extends through the bottom plate (62), the mediate plate (61) and the top plate (64), the first balls (63) and the second balls (65) are securely received in the wheel seat (60). Therefore, a user is able to use the wheel assembly to adapt to any kind of cart for transporting a load.

However, deficiencies of this design cause a lot of troubles, which are as follows:

The first balls (63) and second balls (65) have to be placed in position manually, which is too time consuming and causes cost increase.

In order to allow the first balls (63) and second balls (65) to rotate freely in the wheel seat (60), a gap A is defined between the bottom plate (62) and the mediate plate (61) and between the mediate plate (61) and the top plate (64). Due to the existence of the gap A, pollutant, such as mud, grease, water . . . easily interferes the operation of the first and second balls (63,65). Eventually, the operation of the first and second balls (63,65) is impaired so as the capability of carrying a load.

With reference to FIG. 5, another conventional wheel assembly includes a wheel seat (70) and a wheel (50) rotatably received in the wheel seat (70). The wheel seat (70) has a bearing (72) interference fitted in the wheel seat (70). The wheel seat (70) is made of plastic so that the capability of carrying a load is limited. Based on the load limitation of the wheel assembly, cracks are easily formed after a long period of service time of this wheel assembly.

To overcome the shortcomings, the present invention tends to provide an improved wheel assembly to mitigate and obviate the aforementioned problems.

### SUMMARY OF THE INVENTION

The primary objective of the present invention is to provide an improved wheel assembly having a bearing rested in a bearing seat and clamped by claws that are formed on an inner periphery of the bearing seat. An annular cover is mounted on top of the bearing and has an annularly formed central plate to abut a top face of the bearing so that the bearing is securely seated in the bearing seat.

Another advantageous feature of the present invention is that the bearing has a centrally defined hole, an inner tube securely abutted to an inner periphery of the hole and an outer tube securely abutted to an outer periphery of the hole. The inner tube has an axial length larger than that of the outer tube such that when the central plate of the annular cover engages with the inner tube, the bearing is further positioned.

Still another advantageous feature of the present invention is that the annular cover has an outer skirt integrally formed on an outer edge of the annular cover. The wheel seat has a protruded rim integrally formed to correspond to the annular cover such that after the combination of the annular and the rim, pollutant is kept from interfering the operation of the bearing.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of the wheel assembly of the present invention;

FIG. 2 is an exploded perspective view of the wheel assembly of the present invention in FIG. 1;

FIG. 3 is a side plan view of the wheel assembly with partial in cross section;

FIG. 4 is a side plan view of a conventional wheel assembly with partial in cross section; and

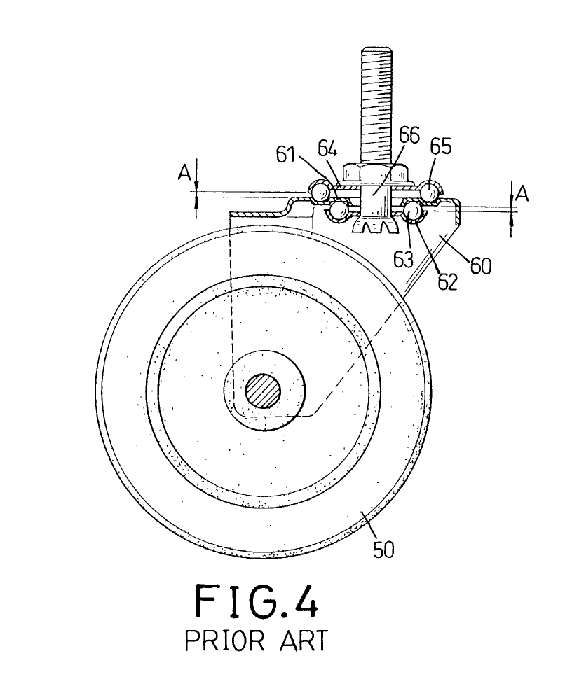

FIG. 5 is a perspective view of a still conventional wheel assembly.

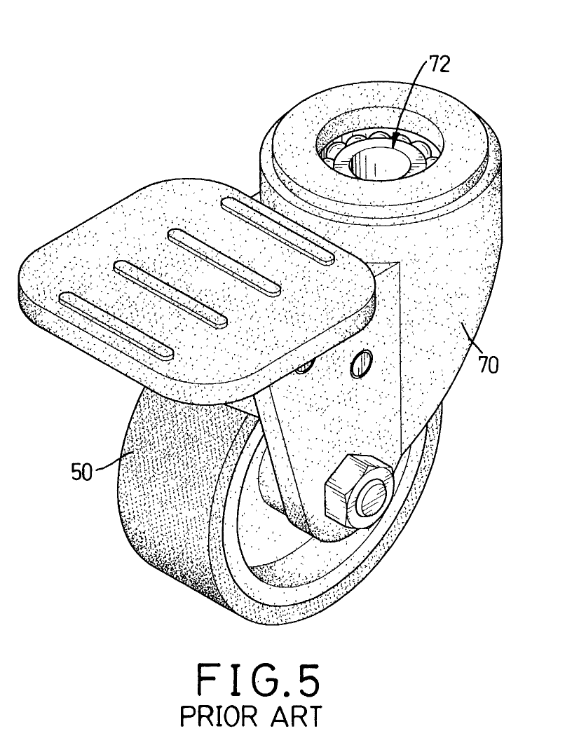

### DETAILED DESCRIPTION OF THE PREFERRED EMBODIMENT

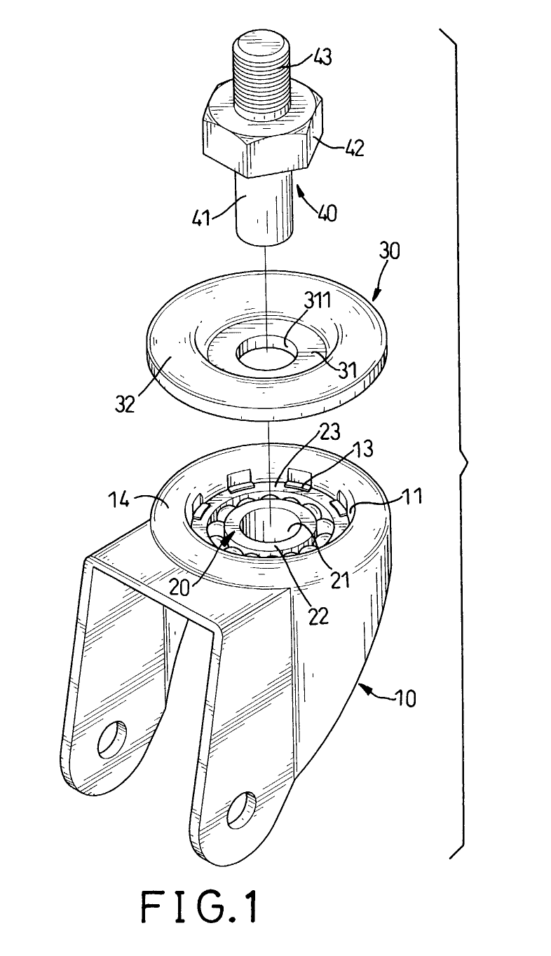

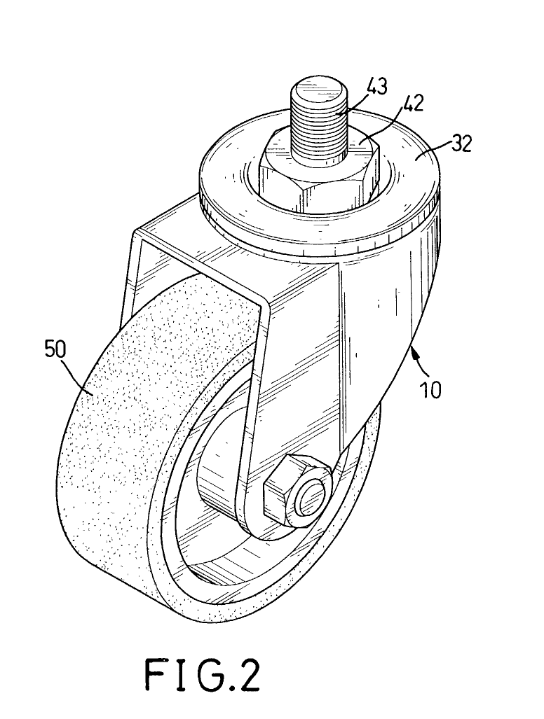

With reference to FIGS. 1 and 2, the wheel assembly in accordance with the present invention includes a wheel seat (10), a bearing (20), an annular cover (30), a positioning bolt (40) and a wheel (50). The wheel seat (10) has a through hole (11) defined in the wheel seat (10) for receiving therein the bearing (20), multiple claws (13) integrally formed on an inner periphery of the through hole (11) to abut a top face of the bearing (20) and an annularly formed, protruded rim (14) integrally formed around a top periphery defining the through hole (11).

The bearing (20), received in the through hole (11) and clamped by the claws (13), has a path (21) communicating with the through hole (11), a inner tube (22) securely abutted to an inner periphery of the path (21) and an outer tube (23) securely abutted to an outer periphery of the path (21). The inner tube (21) has an axial length larger than that of the outer tube (23) and both the top end and bottom end of the inner tube (22) exceed the top and bottom end of the outer tube (23).

The annular cover (30) has a depressed portion with an annularly formed central plate (31) having a central passage (311) corresponding to the through hole (11) of the wheel seat (10) and an annularly formed, downwardly extending skirt (32) to correspond to the rim (14).

The positioning bolt (40) has a shank (41) extending downward to correspond to the path (21), a nut (42) integrally formed on the shank (41) and a threaded end (43) oppositely formed relative to the shank (41).

The wheel (50) is rotatably received in the wheel seat (10) by a securing device, such as a bolt-nut combination as shown in FIG. 2. Of course, other conventional technique to secure the wheel (50) in the wheel seat (10) to allow the wheel (50) to freely rotate in the wheel seat (10) may also be applied.

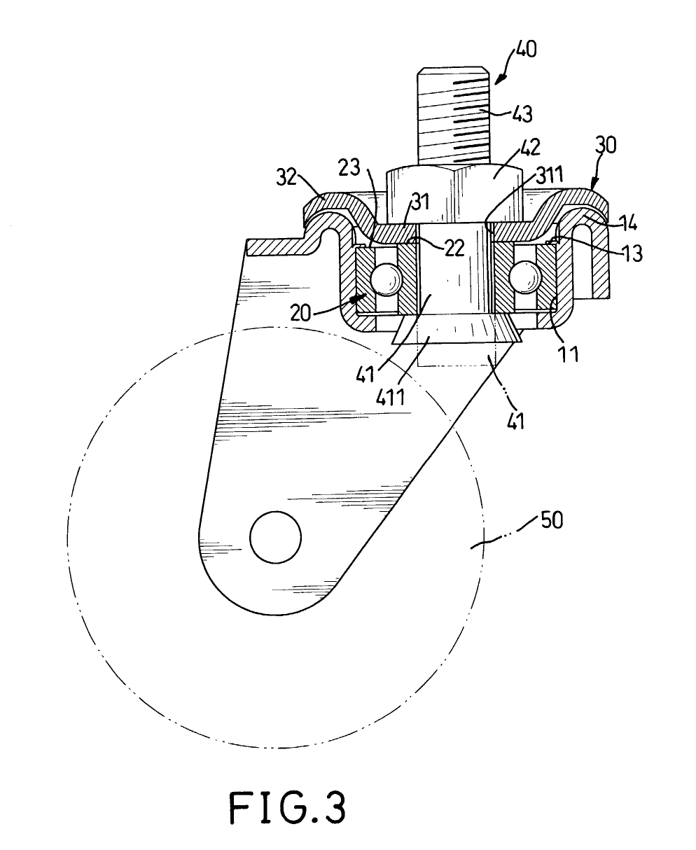

In assembly, with reference to FIG. 3, the bearing (20) is clamped by the claws (13) and then the central plate (31) formed on the depressed portion of the annular cover (30) engages with the top end of the inner tube (22) to further secure the bearing (20) in the wheel seat (10). While the central plate (31) engages with the top end of the inner tube (22), the skirt (32) is on top of the rim (14) so that the top portion of the bearing (20) is enclosed by the annular cover (30). Thereafter, the positioning bolt (40) extends through the passage (311) of the annular cover (30), the path (21) of the bearing (20) and out of the wheel seat (10) to secure the combination of the annular cover (30) and the wheel seat (10). It is to be noted that to ensure the combination between the annular cover (30) and the wheel seat (10), a free end of the shank (41) is formed to have a conical head (411) so as to securely abut a bottom end of the inner tube (22).

From the foregoing description, it is concluded that the bearing (20) has two different mechanisms to respectively ensure the location of the bearing in the wheel seat (10), one is the claws (13) integrally formed on the inner periphery defining the through hole (11) and the other one is the central plate (31) of the annular cover (30) to abut the top end of the inner tube (22). Therefore, the bearing (20) is firmly positioned in the wheel seat (10).

Still, because the skirt (32) is on top of the annularly formed, protruded rim (14) of the wheel seat (10), pollutant is kept away from interfering the operation of the bearing (20) inside the wheel seat (10).

Furthermore, the wheel seat (10), the bearing (20), the annular cover (30) and the positioning bolt (40) are made of non-plastic material, preferably steel, so that the capability to carry a load is large. Therefore, the wheel assembly of the present invention dramatically decreases the expense in manufacture and the process in assembly.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A wheel assembly for a cart, the wheel assembly comprising:
a wheel seat having a through hole defined through the wheel seat to receive therein a bearing, multiple claws formed on an inner periphery defining the through hole to abut a top face of the bearing, and an annular rim formed around a top periphery defining the through hole, wherein the bearing has a path corresponding to the through hole of the wheel seat;
an annular cover having a central plate formed on a depressed portion of the annular cover to abut the top face of the bearing, a passage defined in the central plate to communicate with the path of the bearing and an annularly formed, protruded skirt extending downward from the annular cover to correspond to the annular rim so as to securely sandwich the bearing inside the wheel seat;
a positioning bolt having a shank extending through the passage, the path and the wheel seat and having a conical head formed on a free end of the positioning bolt to abut a bottom face of the bearing, a nut integrally formed with the shank to engage with the central plate and a threaded end oppositely formed relative to the shank; and
a wheel rotatably received in the wheel seat,
whereby, abutment of the conical head to the bottom face of the bearing and the engagement of the nut and the central plate secure the bearing in the wheel seat, and
after the annular cover is mounted on top of the wheel seat, corresponding relationship between the skirt and the annular rim prevents pollutant from entering the bearing.

2. The wheel assembly as claimed in claim 1, wherein bearing has an inner tube securely abutted to an inner periphery defining the path and an outer tube securely abutted to an outer periphery defining the path, wherein the inner tube has an axial length larger than an axial length of the outer tube.

3. The wheel assembly as claimed in claim 2, wherein the central plate abuts a top face of the inner tube and the conical head abuts a bottom face of the inner tube.
